(19) United States
(12) Patent Application Publication
(10) Pub. No.: US 2001/0016912 A1
(43) Pub. Date: Aug. 23, 2001

(54) Network printing system with fingerprint authentication function and recording medium for recording print program for the same

(75) Inventor: Nobuo Takahashi, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/792,023

(22) Filed: Feb. 21, 2001

(30) Foreign Application Priority Data
Feb. 22, 2000 (JP) 2000-044349

(51) Int. Cl. G06F 12/14

(52) U.S. Cl. 713/200; 713/182

(57) ABSTRACT

A network printing system with fingerprint authentication function is provided that can improve the security of print results of a printer. A personal computer 2 accepts a print instruction and requires an operator to enter a fingerprint of the operator. A fingerprint input section 1 receives the fingerprint of the operator and issues first fingerprint pattern data S1. The personal computer 2 converts the first fingerprint pattern data S1 into first fingerprint authentication data S2a. The print data S2b is issued to the communication line 3, together with the first fingerprint authentication data S2a. The printer 4 receives the print data S2b and stores it into the print data memory 5. The operator inputs the fingerprint input at the print instruction to the fingerprint input section 6. The printer 4 converts the second fingerprint pattern data S6 into second fingerprint authentication data. The printer 4 retrieves the print data memory 5, based on the second fingerprint authentication data, and then prints out it if the corresponding print data S5b exists.

### BACKGROUND OF THE INVENTION

The present invention relates to a network printing system with fingerprint authentication function. Particularly, the present invention relates to a network printing system with fingerprint authentication function suitable for environments where plural data processing means share a single printer via a communication line. Moreover, the present invention relates a recording medium used to the network printing system, on which a print program is stored.

In the network printing system, plural data processing means (e.g. personal computers) share a sole printer via a communication line. The network printing system implements its printing operation in the order of sets of print data sent from respective personal computers or implements its printing operation based on the priority information added to print data. In the network printing system, printing is not often implemented with the state desired by an operator of each personal computer. For example, in order to prevent print results from being read by others, it is needed that an operator stands by the printer immediately after a personal computer has transmitted print data and waits for print results ejected from the printer. When the operator does not collect the print results immediately after transmission of print data, the printed sheets may be left without collection. In such a case, the loss, stain, and information leakage of print results and pileup of sheets at the printer output may occur.

In order to solve the above-mentioned problems, JP-A No. 4238/1994 and JP-A No. 81154/1995 disclose the network printing system that can improve disadvantages in the prior art by previously registering identification information for identifying a personal, such as the password, fingerprint data, voice print of an operator.

However, the network printing system with the configuration disclosed in the above publication has the disadvantage that the security function to print results is insufficient since the fingerprint data of an operator is handled equally to a fixed password.

### SUMMARY OF THE INVENTION

The present invention is made to solve the above-mentioned problems. An objective of the present invention is to provide a network printer with fingerprint authentication function that can improve the print result security function using fingerprint data of an operator.

Moreover, another objective of the present invention is to provide a recording medium on which a print program used for the network printer is recorded, according to the present invention.

According to the present invention, a network printing system with fingerprint authentication function, comprises plural first fingerprint input means each for capturing the fingerprint pattern of a finger of an operator and then issuing first fingerprint pattern data; plural data processing means each for converting the first fingerprint pattern data into first fingerprint authentication data suitable for authentication for the operator, creating print data under control of the operator, adding the first fingerprint authentication data to the print data, and then outputting the resultant print data; a communication line for transmitting the print data and the first fingerprint authentication data, output from each of the plural data processing means; a memory for storing the print data and the first fingerprint authentication data, transmitted via the communication line; second fingerprint input means for capturing the fingerprint pattern of the finger of the operator and then outputting second fingerprint pattern data; and a printer for converting the second fingerprint pattern data into second fingerprint authentication data suitable for authentication of the operator, verifying the second fingerprint authentication data against the first fingerprint authentication data stored in the memory, capturing print data corresponding to the first fingerprint authentication data among sets of print data stored in the memory when the second fingerprint authentication data coincides with the first fingerprint authentication data, and then performing a printing operation.

In another aspect of the invention, a network printing system with fingerprint authentication function, comprises plural first fingerprint input means each for capturing the fingerprint pattern of a finger of an operator and then issuing first fingerprint pattern data; plural data processing means each for converting the first fingerprint pattern data into first fingerprint authentication data suitable for authentication for the operator, registering the first fingerprint authentication data, creating print data under control of the operator, adding the first fingerprint authentication data to the print data, and then outputting the resultant print data; a communication line for transmitting the print data and the first fingerprint authentication data, output from each of the plural data processing means; a memory for storing the print data and the first fingerprint authentication data, transmitted via the communication line; second fingerprint input means for capturing the fingerprint pattern of the finger of the operator and then outputting second fingerprint pattern data; and a printer for converting the second fingerprint pattern data into second fingerprint authentication data suitable for authentication of the operator, verifying the second fingerprint authentication data against the first fingerprint authentication data stored in the memory, capturing print data corresponding to the first fingerprint authentication data among sets of print data stored in the memory when the second fingerprint authentication data coincides with the first fingerprint authentication data, and then performing a printing operation.

In another aspect of the invention, a network printing system with fingerprint authentication function, comprises plural first fingerprint input means each for capturing the fingerprint pattern of a finger of an operator and then issuing first fingerprint pattern data; plural first data processing means each for converting the first fingerprint pattern data into first fingerprint authentication data suitable for authentication for the operator, creating print data under control of the operator, adding the first fingerprint authentication data to the print data, and then outputting the resultant print data; a communication line for transmitting the print data and the first fingerprint authentication data, output from each of the plural first data processing means; a memory for storing the print data and the first fingerprint authentication data, transmitted via the communication line; second fingerprint input means for capturing the fingerprint pattern of the finger of the operator and then outputting second fingerprint pattern data; second data processing means for converting the second fingerprint pattern data into second fingerprint authentication data suitable for authentication of the operator, verifying the second fingerprint authentication data against the first fingerprint authentication data stored in said memory, and reading out print data corresponding to the first fingerprint authentication data among sets of print data stored in the memory when said second fingerprint authentication data coincides with the first fingerprint authentication data; and a printer for capturing said print data read out by the second data processing means and performing a printing operation.

In another aspect of the invention, a network printing system with fingerprint authentication function, comprises plural first fingerprint input means each for capturing the fingerprint pattern of a finger of an operator and then issuing first fingerprint pattern data; plural data processing means each for converting the first fingerprint pattern data into first fingerprint authentication data suitable for authentication for the operator, creating print data under control of the operator, adding fingerprint management information to the first fingerprint authentication data, the fingerprint management information representing a personal or management unit to which the first fingerprint authentication data belong, and then outputting the resultant data together with the print data; a communication line for transmitting the print data, the first fingerprint authentication data and the fingerprint management information, output from each of the plural data processing means; a memory for storing the print data, the first fingerprint authentication data and the fingerprint management information, transmitted via the communication line; second fingerprint input means for capturing the fingerprint pattern of the finger of the operator and then outputting second fingerprint pattern data; a database for storing the first fingerprint authentication data and the fingerprint management information transmitted via the communication line; and a printer for converting the second fingerprint pattern data into second fingerprint authentication data suitable for authentication of the operator, reading out the fingerprint management information corresponding to the second fingerprint authentication data from the database, capturing print data corresponding to the fingerprint management information among sets of print data stored in the memory, and performing a printing operation.

In another aspect of the invention, a network printing system with fingerprint authentication function, comprises plural first fingerprint input means each for capturing the fingerprint pattern of a finger of an operator and then issuing first fingerprint pattern data; plural data processing means each for converting the first fingerprint pattern data into first fingerprint authentication data suitable for authentication for the operator, registering the first fingerprint authentication data, creating print data under control of the operator, adding fingerprint management information to the first fingerprint authentication data based on a print instruction, the fingerprint management information representing a personal or management unit to which the first fingerprint authentication data belong, and then outputting the resultant data together with the print data; a communication line for transmitting the print data, the first fingerprint authentication data and the fingerprint management information, output from each of the plural data processing means; a memory for storing the print data, the first fingerprint authentication data and the fingerprint management information, transmitted via the communication line; second fingerprint input means for capturing the fingerprint pattern of the finger of the operator and then outputting second fingerprint pattern data; a database for storing the first fingerprint authentication data and the fingerprint management information transmitted via the communication line; and a printer for converting the second fingerprint pattern data into second fingerprint authentication data suitable for authentication of the operator, reading out the fingerprint management information corresponding to the second fingerprint authentication data from the database, capturing print data corresponding to the fingerprint management information among sets of print data stored in the memory, and performing a printing operation.

In another aspect of the invention, a network printing system with fingerprint authentication function, comprises plural first fingerprint input means each for capturing the fingerprint pattern of a finger of an operator and then issuing first fingerprint pattern data; plural first data processing means each for converting the first fingerprint pattern data into first fingerprint authentication data suitable for authentication for the operator, creating print data under control of the operator, adding fingerprint management information to the first fingerprint authentication data, the fingerprint management information representing a personal or management unit to which the first fingerprint authentication data belong, and then outputting the resultant data together with the print data; a communication line for transmitting the print data, the first fingerprint authentication data and the fingerprint management information, output from each of the plural data processing means; a memory for storing the print data, the first fingerprint authentication data and the fingerprint management information, transmitted via the communication line; second fingerprint input means for capturing the fingerprint pattern of the finger of the operator and then outputting second fingerprint pattern data; a database for storing the first fingerprint authentication data and the fingerprint management information transmitted via the communication line; and second data processing means for converting the second fingerprint pattern data into second fingerprint authentication data suitable for authentication of the operator, reading out the fingerprint management information corresponding to the second fingerprint authentication data from said database, and capturing print data corresponding to the fingerprint management information among sets of print data stored in the memory; and a printer for capturing the print data read out of the second data processing means and printing the print data.

In another aspect of the invention, a network printing system with fingerprint authentication function, comprises plural first fingerprint input means each for capturing the fingerprint pattern of a finger of an operator and then issuing first fingerprint pattern data; plural data processing means each for converting the first fingerprint pattern data into first fingerprint authentication data suitable for authentication for the operator, creating print data under control of the operator, adding fingerprint management information to the first fingerprint authentication data, the fingerprint management information representing a personal or management unit to which the first fingerprint authentication data belong, and then outputting the resultant data together with the print data; a communication line for transmitting the print data, the fingerprint authentication data, and the fingerprint management information, output from the data processing means; a database for storing the first fingerprint authentication data and fingerprint management information, transmitted via the communication line; an authentication server for reading out the fingerprint management information corresponding to second fingerprint authentication data from the database; a memory for storing the print data, the first fingerprint authentication data, and the fingerprint management information, transmitted via the communication line; second fingerprint input means for capturing the fingerprint pattern of a finger of each operator and then outputting second fingerprint pattern data; and a printer for converting the second fingerprint pattern data into second fingerprint authentication data suitable for authentication of the operator, capturing print data corresponding to the fingerprint management information among sets of print data stored in the memory, and printing the captured print data.

Moreover, the present invention relates to a recording medium, on which a program for making a computer execute print control, the program making the computer execute the steps of capturing the fingerprint pattern of a finger of an operator and then creating first fingerprint pattern data; converting the first fingerprint pattern data into first fingerprint authentication data suitable for authentication for the operator, creating print data under control of the operator, adding the first fingerprint authentication data to the print data, and then transmitting the resultant print data; storing the print data and the first fingerprint authentication data transmitted, in a memory; capturing the fingerprint pattern of a finger of each operator and then creating second fingerprint pattern data; and converting the second fingerprint pattern data into second fingerprint authentication data suitable for authentication of the operator, verifying the second fingerprint authentication data against the first fingerprint authentication data stored in the memory, capturing print data corresponding to the first fingerprint authentication data among sets of print data stored in the memory when the second fingerprint authentication data coincides with the first fingerprint authentication data; and then performing a printing operation.

In another aspect, the present invention relates to a recording medium, on which a program for making a computer execute print control, the program making the computer execute the steps of capturing the fingerprint pattern of a finger of an operator and then creating first fingerprint pattern data; converting the first fingerprint pattern data into first fingerprint authentication data suitable for authentication for said operator, registering the first fingerprint authentication data, creating print data under control of the operator, adding the first fingerprint authentication data to the print data, based on a print instruction, and then transmitting the resultant print data; storing the print data and the first fingerprint authentication data transmitted, in a memory; capturing the fingerprint pattern of a finger of each operator and then creating second fingerprint pattern data; and converting the second fingerprint pattern data into second fingerprint authentication data suitable for authentication of the operator, verifying the second fingerprint authentication data against the first fingerprint authentication data stored in the memory, capturing print data corresponding to the first fingerprint authentication data among sets of print data stored in the memory when the second fingerprint authentication data coincides with the first fingerprint authentication data; and then performing a printing operation.

In another aspect, the present invention relates to a recording medium, on which a program for making a computer execute print control, the program making the computer execute the steps of capturing the fingerprint pattern of a finger of an operator and then creating first fingerprint pattern data; converting the first fingerprint pattern data into first fingerprint authentication data suitable for authentication of the operator, creating print data under control of the operator, adding the first fingerprint authentication data to the print data, and then transmitting the resultant print data; storing the print data and the first fingerprint authentication data transmitted, in a memory; capturing the fingerprint pattern of a finger of each operator and then creating second fingerprint pattern data; converting the second fingerprint pattern data into second fingerprint authentication data suitable for authentication of the operator, verifying the second fingerprint authentication data against the first fingerprint authentication data stored in the memory, reading out print data corresponding to the first fingerprint authentication data among sets of print data stored in the memory when the second fingerprint authentication data coincides with the first fingerprint authentication data; and capturing the print data and performing a printing operation.

In another aspect, the present invention relates to a recording medium, on which a program for making a computer execute print control, the program making the computer execute the steps of capturing the fingerprint pattern of a finger of an operator and then creating first fingerprint pattern data; converting the first fingerprint pattern data into first fingerprint authentication data suitable for authentication of the operator, creating print data under control of the operator, adding fingerprint management information to the first fingerprint authentication data, the fingerprint management information representing a personal or management unit to which the first fingerprint authentication data belong, and then transmitting the resultant data together with the print data; storing the print data, the first fingerprint authentication data, and the fingerprint management information transmitted, in a memory; capturing the fingerprint pattern of a finger of each operator and then creating second fingerprint authentication data; storing the first fingerprint authentication data and the fingerprint management information in a database; and converting the second fingerprint pattern data into second fingerprint authentication data suitable for authentication of the operator, reading out the fingerprint management information corresponding to the second fingerprint authentication data from the database, capturing print data corresponding to the fingerprint authentication management information among sets of print data stored in the memory, and performing a printing operation.

In another aspect, the present invention relates to a recording medium, on which a program for making a computer execute print control, the program making the computer execute the steps of capturing the fingerprint pattern of a finger of an operator and then creating first fingerprint pattern data; converting the first fingerprint pattern data into first fingerprint authentication data suitable for authentication of the operator, registering the first fingerprint authentication data, creating print data under control of the operator, adding fingerprint management information to the first fingerprint authentication data based on a print instruction, the fingerprint management information representing a personal or management unit to which the first fingerprint authentication data belong, and then outputting the resultant data together with the print data; storing the print data, the first fingerprint authentication data, and the fingerprint management information transmitted, in a memory; capturing the fingerprint pattern of a finger of each operator and then creating second fingerprint pattern data; storing the first fingerprint authentication data and the fingerprint management information transmitted, in a database; and converting the second fingerprint pattern data into second fingerprint authentication data suitable for authentication of the operator, reading out the fingerprint management information corresponding to the second fingerprint authentication data from the database, capturing print data corresponding to the fingerprint authentication management information among sets of print data stored in the memory, and performing a printing operation.

In another aspect, the present invention relates to a recording medium, on which a program for making a computer execute print control, the program making the computer execute the steps of capturing the fingerprint pattern of a finger of an operator and then creating first fingerprint pattern data; converting the first fingerprint pattern data into first fingerprint authentication data suitable for authentication of the operator, creating print data under control of the operator, adding fingerprint management information to the first fingerprint authentication data, the fingerprint management information representing a personal or management unit to which the first fingerprint authentication data belong, and then transmitting the resultant data together with the print data; storing the print data, the first fingerprint authentication data, and the fingerprint management information transmitted, in a memory; capturing the fingerprint pattern of a finger of each operator and then creating second fingerprint authentication data; storing the first fingerprint authentication data and the fingerprint management information transmitted, in a database; converting the second fingerprint pattern data into second fingerprint authentication data suitable for authentication of the operator, reading out the fingerprint management information corresponding to the second fingerprint authentication data from the database, and reading out print data corresponding to the fingerprint management information among sets of print data stored in the memory; and capturing and printing the print data read out.

In another aspect, the present invention relates to a recording medium, on which a program for making a computer execute print control, the program making the computer execute the steps of capturing the fingerprint pattern of a finger of an operator and then creating first fingerprint pattern data; converting the first fingerprint pattern data into first fingerprint authentication data suitable for authentication of the operator, creating print data under control of the operator, adding fingerprint management information to the first fingerprint authentication data, the fingerprint management information representing a personal or management unit to which the first fingerprint authentication data belong, and then outputting the resultant data together with the print data; storing the first fingerprint authentication data and fingerprint management information transmitted, in a database; reading out the fingerprint management information corresponding to second fingerprint authentication data from the database; storing the print data and the first fingerprint authentication data, and the fingerprint management information transmitted via the communication line, in a memory; capturing the fingerprint pattern of a finger of each operator and then creating second fingerprint pattern data; and converting the second fingerprint pattern data into second fingerprint authentication data suitable for authentication of the operator, capturing print data corresponding to the fingerprint management information among sets of print data stored in the memory, and printing the captured print data.

### BRIEF DESCRIPTION OF THE DRAWINGS

This and other objects, features and advantages of the present invention will become more apparent upon a reading of the following detailed description and drawings, in which:

FIG. 1 is a block diagram illustrating the electrical configuration of a network printing system with fingerprint authentication function, according to the first embodiment of the present invention;

FIG. 2 is a flowchart explaining the operation of the printer 2;

FIG. 3 is a flowchart explaining the operation of the printer 4;

FIG. 4 is a flowchart explaining the operation of the personal computer 2;

FIG. 5 is a flowchart explaining the operation of the personal computer 4;

FIG. 6 is a block diagram illustrating the electrical configuration of a network printing system with fingerprint authentication function, according to the third embodiment of the present invention;

FIG. 7 is a flowchart explaining the operation of a network printing system with fingerprint authentication function;

FIG. 8 is a block diagram illustrating the electrical configuration of a network printing system with fingerprint authentication function, according to the fourth embodiment of the present invention;

FIG. 9 is a flowchart explaining the operation of registering first fingerprint authentication data S2a and fingerprint management information S2c to the fingerprint identification database 8;

FIG. 10 is a flowchart explaining the operation of the personal computer 2A;

FIG. 11 is a flowchart explaining the operation of the printer 4B;

FIG. 12 is a flowchart explaining the operation of registering fingerprint authentication data S2a to the personal computer 2A;

FIG. 13 is a flowchart explaining the operation of the personal computer 2A;

FIG. 14 is a block diagram illustrating the electrical configuration of a network printing system with fingerprint authentication function, according to the sixth embodiment of the present invention;

FIG. 15 is a flowchart explaining the operation of a network printing system with fingerprint authentication function;

FIG. 16 is a block diagram illustrating the electrical configuration of a network printing system with fingerprint authentication function, according to the seventh embodiment of the present invention;

FIG. 17 is a flowchart explaining the operation of registering first fingerprint authentication data S2a and fingerprint management information S2c to the fingerprint identification database 8;

FIG. 18 is a flowchart explaining the operation of the personal computer 2A; and

FIG. 19 is a flowchart explaining the operation of the printer 4.

### DESCRIPTION OF THE EMBODIMENTS

Embodiments according to the present invention will be described below by referring to the attached drawings.

First Embodiment

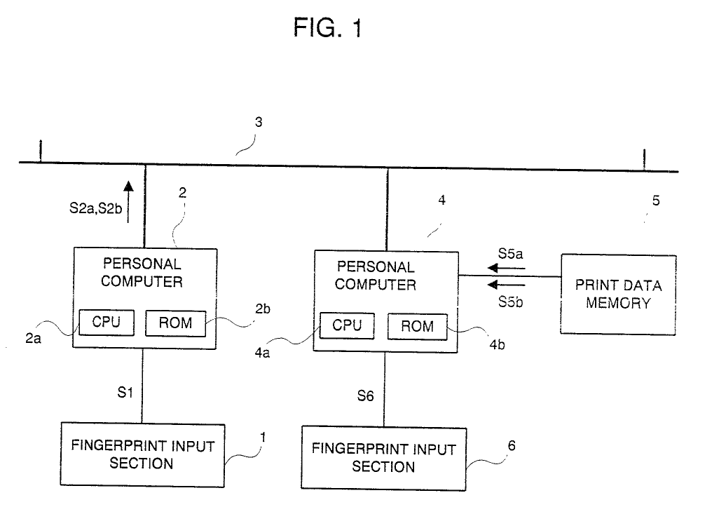

FIG. 1 is a block diagram illustrating the electrical configuration of a network printing system with fingerprint authentication function, according to the first embodiment of the present invention.

The network printing system with fingerprint authentication function has a first fingerprint input section 1, as shown in FIG. 1. The fingerprint input section 1, which is formed of, for example, a fingerprint sensor for converting the roughness of a fingerprint into electrical signals, has the function of capturing the fingerprint pattern of an arbitrary finger of an operator and then outputting first fingerprint pattern data S1. The fingerprint input section 1 is connected to the data processing means (for example, a personal computer) 2. The personal computer 2 converts the first fingerprint pattern data S1 into first fingerprint authentication data S2a suitable for authentication of an operator and creates print data S2b under control of the operator. Meanwhile, the personal computer 2 adds the first fingerprint authentication data S2a to the print data S2b and then outputs the resultant data. The first fingerprint authentication data S2a is formed of, for example, information representing the relationship between locations of features of a fingerprint pattern. The personal computer 2 includes a central processing unit (hereinafter referred to as CPU) 2a for controlling the whole of the personal computer 2 and a recording medium (for example, a read-only memory (ROM)) 2b on which a print program for operating the CPU 2a is recorded.

A printer 4 is connected to a personal computer 2 via the communication line 3. The communication line 3, which is formed of a LAN (Local Area Network), transmits the print data S2b and the first fingerprint authentication data S2a, output from the personal computer 2. The printer 4 is connected to the memory (for example, a print data memory) 5. The print data memory 5 receives the print data S2b and the first fingerprint authentication data S2a transmitted via the communication line 3 and respectively stores them as the print data S5b and as the first fingerprint authentication data S5a. The printer 4 is connected to the second fingerprint input section 6. The fingerprint input section 6 has the function of capturing the fingerprint pattern of a given finger of an operator and outputting the second fingerprint pattern data S6. The printer 4 converts the second fingerprint pattern data S6 into the second fingerprint authentication data suitable for authentication of an operator and verifies the first fingerprint authentication data against the first fingerprint authentication data S5a stored in the print data memory 5. When the second fingerprint authentication data coincides with the first fingerprint authentication data S5a, the printer 4 implements its printing operation by capturing print data corresponding to the first fingerprint authentication data S5a among sets of print data S5b stored in the print data memory 5. The printer 4 includes a CPU 4a for controlling the whole of the personal computer 4 and a recording medium 4b that records a print program for operating the CPU 4a.

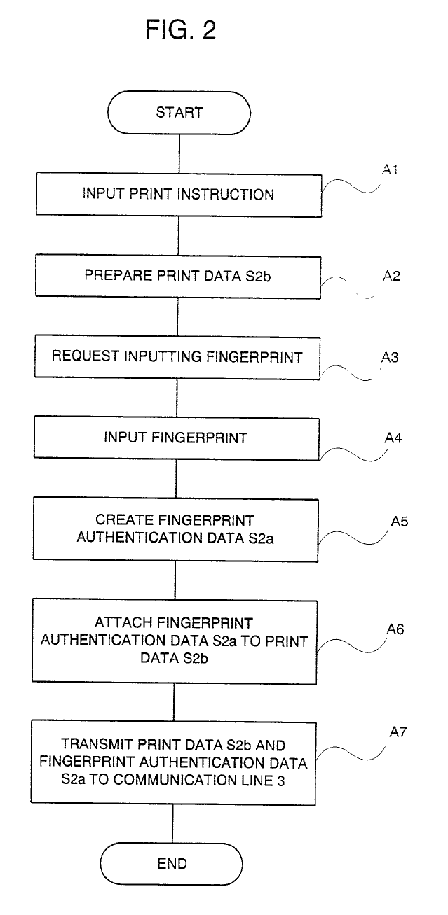

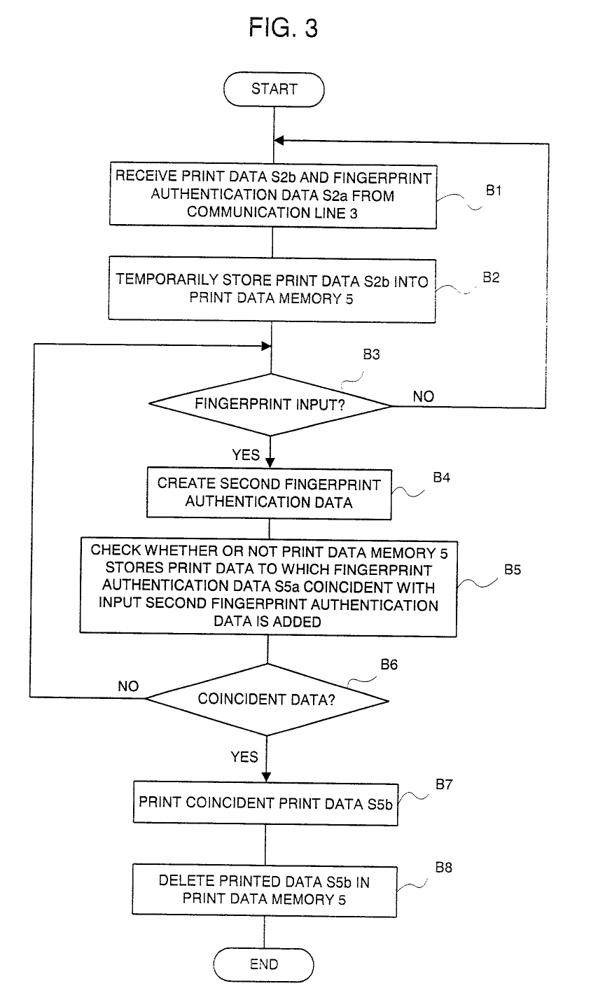

FIG. 2 is a flow chart explaining the operation of a network printing system with fingerprint authentication function. FIG. 3 is a flow chart explaining the operation of a network printing system with fingerprint authentication function. In more detail, FIG. 2 is a flow chart explaining the operation of the personal computer 2. FIG. 3 is a flow chart explaining the operation of the personal computer 4.

The operation of the network printing system with the fingerprint authentication function will be explained below by referring to FIGS. 2 and 3.

A print instruction, as shown in FIG. 2, is entered to the personal computer 2 with the operation of an operator (step A1) to be ready for the print data S2b (step A2). The personal computer 2 requests the operator to input a fingerprint thereof (step A3). The operator enters his/her fingerprint (for example, the fingerprint of the index finger of the right hand) to the fingerprint input section 1 (step A4). The fingerprint input section 1 outputs to the first fingerprint pattern data S1. The personal computer 2 receives the first fingerprint pattern data S1 input from the fingerprint input section 1 and then converts it into the first fingerprint authentication data S2a (step A5). The personal computer 2 adds the first fingerprint authentication data S2a to the print data S2b (step A6) and then transmits the resultant data to the communication line 3 (step A7).

The printer 4, as shown in FIG. 3, receives the print data S2b transmitted via the communication line 3 (step B1) and temporarily stores it to the print data memory 5 (step B2). The operator inputs his fingerprint (that is, the fingerprint of the index finger) input in the step A4 after the inputting of the print instruction, to the fingerprint input section 6 (step B3). The fingerprint input section 6 outputs the second fingerprint pattern data S6. The printer 4 receives the second fingerprint pattern data S6 and then converts it into the second fingerprint authentication data (step B4). The printer 4 retrieves whether or not the print data memory has the print data to which the corresponding fingerprint authentication data is added, based on the second fingerprint authentication data (step B5). If the print data memory 5 has the print data S5b to which the corresponding fingerprint authentication data S5 is added (step B6), the printer 4 prints out the print data S5b. Thereafter, the print data S5b printed is deleted from the print data memory 5 (step B8).

In the step B5, unless the print data memory 5 has the print data S5b to which the corresponding fingerprint authentication data S5a is added, the flow goes back to the step B3. The printer 4 does not execute the printing operation. In this embodiment, the printer 4 executes its printing operation in response to the fingerprint of the index finger of the right hand but does not execute in response to the fingerprint of the middle finger of the right hand. In the steps B1, . . . , B8, if the middle finger of the right hand is used instead of the index finger of the right hand, the printer 4 prints out the print data S5b related to the middle finger of the right hand. In this embodiment, it is unnecessary that the personal computer 2 or the printer 4 incorporates a database for verification of fingerprint authentication data. The reason is that the fingerprint is input every time the print instruction is executed and the fingerprint authentication data S2a is added to the print data S2b.

The present embodiment has the following advantages (a) to (e).

The fingerprint authentication data S2a is added to the print data S2b every time the print instruction is executed and the printer 4 performs personal authentication of an operator. Hence, even if a different operator uses the personal computer 2, the printing operation is not performed because the operator is not identified as an authorized person. For that reason, only the operator, which has executed the print instruction, can actually use printer 4 so that the security of the print results can be maintained.

Since the printer 4 authenticates the operator and prints out only the corresponding print data S5b, the operator can easily know that the print results belong thereto.

Since personal authentication is made with the fingerprint of an operator and a specific finger of an operator can be distinguished, a desired set of print data can be selected by relating the type of finger with print data.

If the operator self which has transmitted the print data S2b does not operate the printer 4, the printer 4 does not work. Hence, it is expected that the operator can quickly collect the print results. It can be prevented that printed sheets are piled up at the output of the printer 4.

Since the operator can be reconsider whether or not to start printing, waste printing can be prevented.

Second Embodiment

In the network printing system with fingerprint authentication function of this embodiment, the personal computer 2, shown in FIG. 1, converts the first fingerprint pattern data S1 into the first fingerprint authentication data S2a suitable for an operator and registers the converted result. Then, the personal computer 2 creates the print data S2b under control of the operator and then adds the first fingerprint authentication data S2a to the print data S2b, based on the print instruction, thus outputting the resultant data.

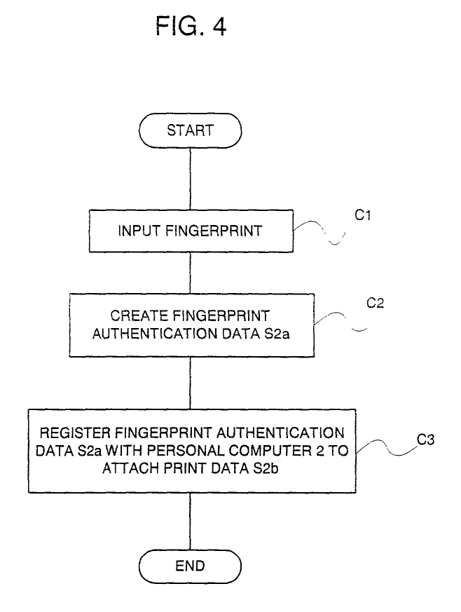

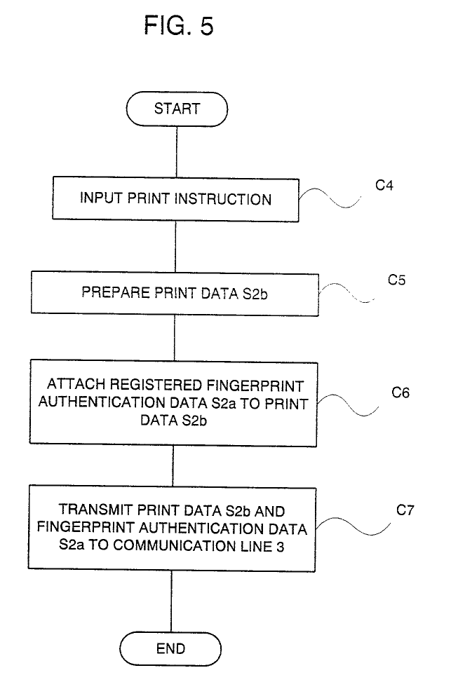

FIG. 4 is a flowchart explaining the operation of the network printing system with fingerprint authentication function. FIG. 5 is a flowchart explaining the operation of the network printing system with fingerprint authentication function. In further detail, FIG. 4 is a flowchart explaining the operation of the personal computer 2. FIG. 5 is a flowchart explaining the operation of the printer 4.

The network printing system with fingerprint authentication network function will be explained below by referring to FIGS. 4 and 5.

In the personal computer 2, an operator, as shown in FIG. 4, inputs a fingerprint thereof (for example, the fingerprint of the index finger of the right hand) to the fingerprint input section 1 (step C1). The fingerprint input section 1 outputs the first fingerprint pattern data S1. The personal computer 2 receives the first fingerprint pattern data S1 and converts it into the first fingerprint authentication data S2a (step C2). The converted data is registered in the personal computer 2 (step C3). Next, the operator, as shown in FIG. 5, inputs a given print instruction during operation of the personal computer 2 (step C4). In accordance with the print instruction, the personal computer 2 prepares the print data S2b (step C5). The first fingerprint authentication data S2a registered is added to the print data S2b (step C6) and the resultant data is transmitted to the communication line 3 (step C7). The printer 4 executes steps similar to the steps B1, . . . , B8 shown in the first embodiment.

According to the second embodiment, since the personal computer 2 registers the first fingerprint authentication data S2a, it is not needed that the operator inputs his/her fingerprint to the fingerprint input section 1 every printing. This configuration can provide simplified control when the operator that operates the personal computer 2 is not changed, in addition to the advantage of the first embodiment.

Third Embodiment

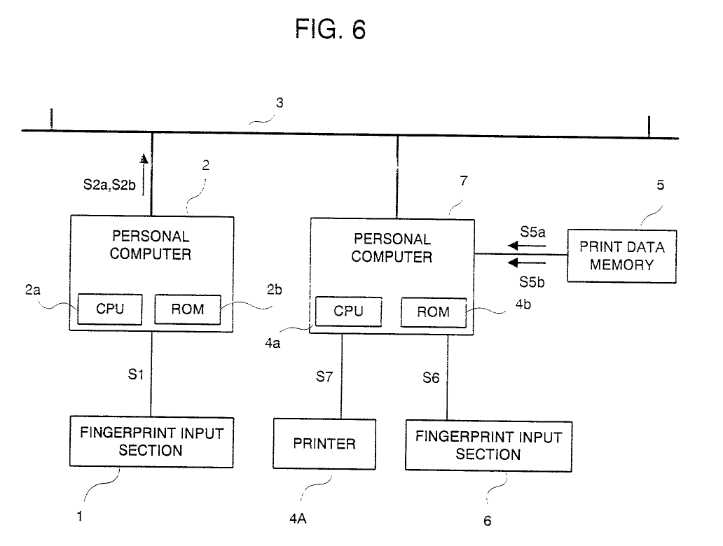

FIG. 6 is a flowchart explaining the electrical configuration of a network printing system with fingerprint authentication function according to the third embodiment of the present invention. Like numerals are attached to the same constituent elements as those in the first embodiment shown in FIG. 1.

The network printing system with fingerprint authentication function in this embodiment differs from that in the first embodiment in the following points. That is, a personal computer 7 is arranged instead of the printer 4 of FIG. 1. The personal printer 7 is connected to a printer 4A having a configuration different from the printer 4. The personal computer 7 converts the second fingerprint pattern data S6 into the second fingerprint authentication data suitable for authentication of an operator and verifies the second fingerprint authentication data against the first fingerprint authentication data S5a stored in the print data memory 5. When the second fingerprint authentication data coincides with the first fingerprint authentication data S5a, the personal computer 7 reads out the print data corresponding to the first fingerprint authentication data S5a among sets of print data S5b stored in the print data memory 5. The personal computer 7 also includes a CPU 7a for controlling the whole of the personal computer 7 and a recording medium (for example, ROM) 7b that records a program for operating the CPU 7a. The printer 4A captures the print data S7 read by the personal computer 7 and implements the printing operation. Operations of other elements are identical to those of the system shown in FIG. 1.

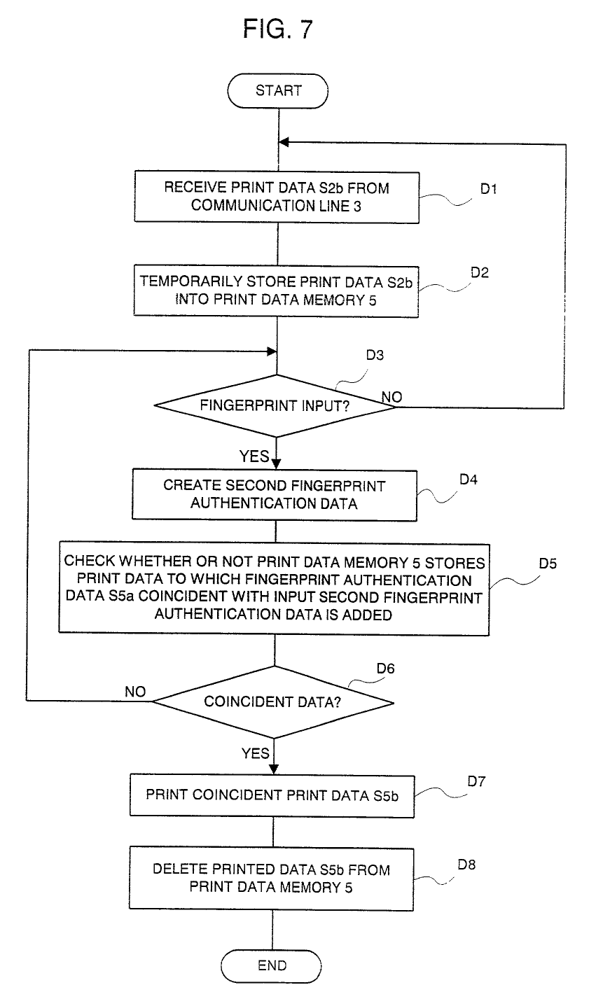

FIG. 7 is a flowchart explaining the operation of a network printing system with fingerprint authentication function in the present embodiment.

The operation of the network printing system with fingerprint authentication function will be described below by referring to FIG. 7.

The personal computer 2 operates in a similar manner to the operation in the first embodiment shown in FIG. 2. The personal computer 7, as shown in FIG. 7, receives the print data S2b transmitted via the communication line 3 (step D1). The print data memory 5 temporarily stores the print data S2b (step D2). The operator inputs his/her fingerprint (that is, the fingerprint of the index finger of the right hand) input by the personal computer 2 at execution of the print instruction, to the fingerprint input section 6 (step D3). The fingerprint input section 6 outputs the second fingerprint pattern data S6. The personal computer 7 receives the second fingerprint pattern data S6 and converts it into the second fingerprint authentication data (step D4).

The personal computer 7 retrieves whether or not the print data memory 5 has the print data to which the corresponding fingerprint authentication data is added, based on the second fingerprint authentication data. If the print data memory 5 has the print data S5b to which the corresponding fingerprint authentication data S5a is added (step D6), the personal computer 7 captures it and transmits the print data S7 to the printer 4A. The printer 4A prints out the print data S7 (step D7). Thereafter, the printed print data S5b is deleted from the print data memory 5 (step D8). In the step D5, if the print data memory 5 does not have print data S5b to which the corresponding fingerprint authentication data S5a is added, the flow goes back to the step D3. Hence, the printer 4A does not implement the printing operation.

As described above, the third embodiment has the advantage of the first embodiment because the personal computer 7 is provided instead of the printer 4 shown in FIG. 1. Moreover, the printer 4A can be realized with the simple configuration that has only the function of printing the print data S7.

Fourth Embodiment

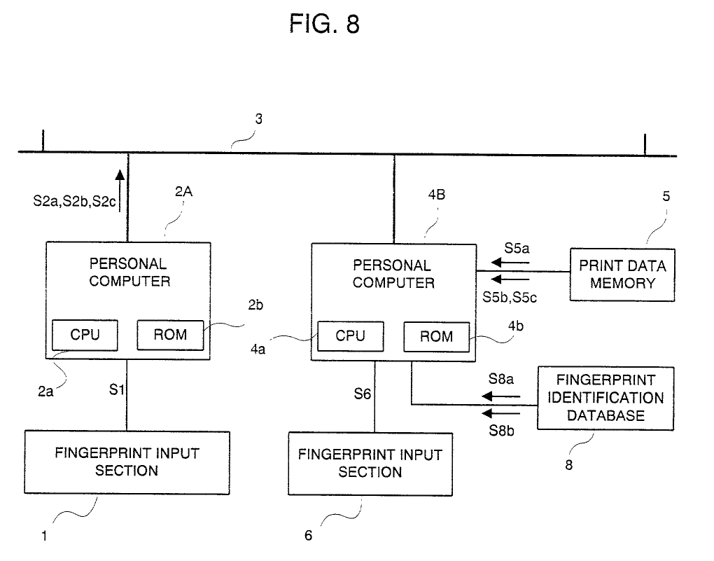

FIG. 8 is a block diagram illustrating the electrical configuration of a network printing system with fingerprint authentication function, according to the fourth embodiment of the present invention. Like numerals are attached to the same constituent elements as those in the first embodiment of FIG. 1.

The network printing system with fingerprint authentication function differs from the first embodiment in the following respects.

That is, a personal computer 2A, in which a different program is recorded, is provided in place of the personal computer 2 shown in FIG. 1. In the network printing system with fingerprint authentication function, a printer 4B with a different configuration is provided in place of the printer 4 in FIG. 1. A database (for example, a fingerprint identification database) 8 is connected to the printer 4B. The personal computer 2A converts the first fingerprint pattern data S1 into the first fingerprint authentication data S2a suitable for authentication of an operator and then creates the print data S2b based on the operation of the operator. The personal computer 2A also adds the fingerprint management information S2c representing the personal or management unit to which the first fingerprint authentication data S2a belongs, to the first fingerprint authentication data S2a and outputs the added data together with the print data S2b.

The fingerprint identification database 8 receives the first fingerprint authentication data S2a and the fingerprint management information S2c transmitted via the communication line 3 and then stores respectively as the first fingerprint authentication data S8a and the fingerprint management information S8c. The printer 4B converts the second fingerprint pattern data S6 into the second fingerprint authentication data suitable for authentication of the operator, reads out the fingerprint management information S8c corresponding to the second fingerprint authentication data from the fingerprint identification database 8. Then, the printer 4 captures the print data corresponding to the fingerprint management information S8c among sets of print data S5b stored in the print data memory 5, thus executing the printing operation. Other operations are similar to those of the first embodiment in FIG. 1.

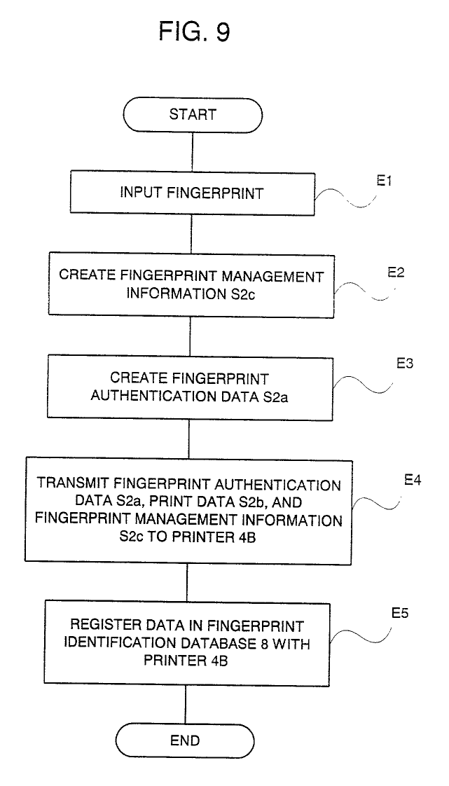

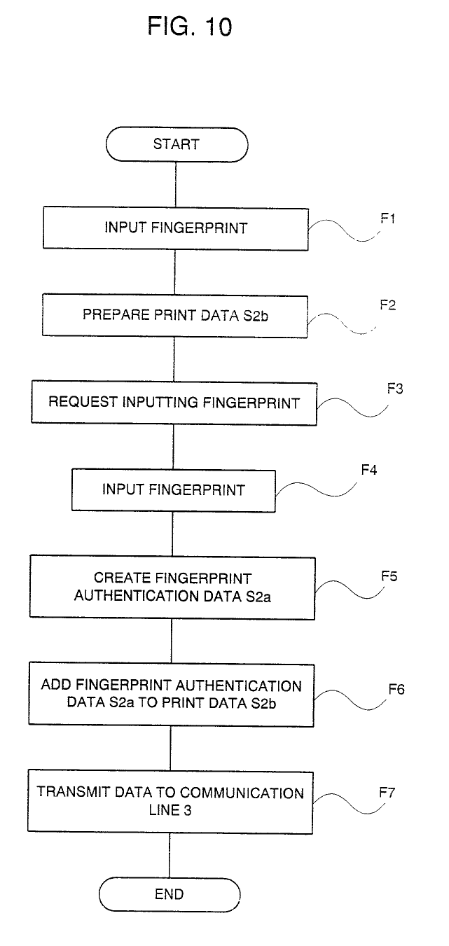

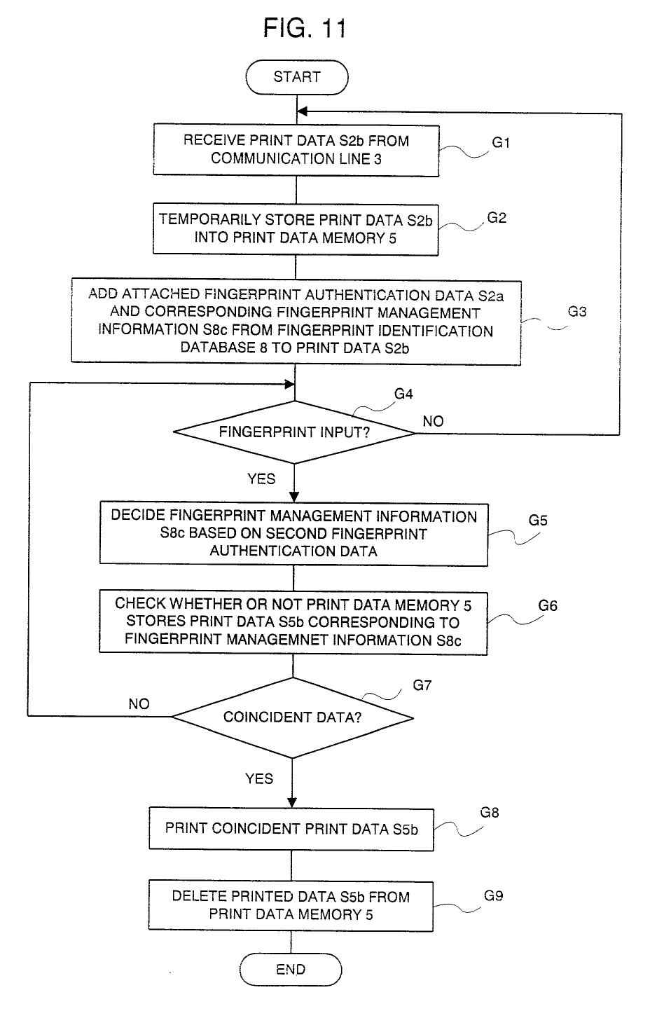

Each of FIGS. 9, 10 and 11 is a flowchart explaining the operation of the network printing system with fingerprint authentication function in the above-mentioned embodiment. FIG. 9 is a flowchart explaining the operation of registering the first fingerprint authentication data S2a and the fingerprint management information S2c in the fingerprint identification database 8. FIG. 10 is a flowchart explaining the operation of the personal computer 2A. FIG. 11 is a flowchart explaining the operation of the printer 4B.

Referring to FIGS. 9, 10 and 11, the operation of the network printing system with fingerprint authentication function will be explained below.

As shown in FIG. 9, the operator inputs his/her fingerprint to the fingerprint input section 1 (step E1). The fingerprint input section 1 outputs the first fingerprint pattern data S1. The operator inputs a personal or management unit to which the fingerprint belongs, to the personal computer 2A (step E2) and creates the fingerprint management information S2c. The personal computer 2A receives the fingerprint pattern data S1 to create the first fingerprint authentication data S2a (step E3). The first management authentication data S2a, the print data S2b, and the fingerprint management information S2c are transmitted to the printer 4B via the communication line 3 (step E4). The first fingerprint authentication data S2a and the fingerprint management information S2c input to the printer 4B are registered in the fingerprint identification database 8 (step E5). The fingerprint identification database 8 can show that plural different fingers belong to the same personal or management unit. When a set of fingerprint authentication data is input, the fingerprint identification database 8 can output the fingerprint management information S8c representing the corresponding personal or management unit. If the definition, “the index finger and the middle finger belong to the same person”, is stored in the fingerprint identification database 8, the operator can output the same fingerprint management information S8c representing the same operator, by inputting the index finger or the middle finger.

The personal computer 2A, as shown in FIG. 10, receives print instructions through the operation of an operator (step F1). The personal computer 2A prepares the print data S2b (step F2) and then request the operator to input a fingerprint (step F3). When the operator inputs his/her fingerprint (for example, the fingerprint of the index finger of the right hand) to the fingerprint input section 1 (step F4), the fingerprint input section 1 outputs the first fingerprint pattern data S1. The personal computer 2A receives the first fingerprint pattern data S1 and then converts it into the first fingerprint authentication data S2a (step F5). The personal computer 2A adds the first fingerprint authentication data S2a to the print data S2b (step F6) and then transmits the added data via the communication line 3 (step F7).

In this example, it is assumed that “the index finger and the middle finger belong to the same person” is defined in the fingerprint identification database 8. The printer 4B, as shown in FIG. 11, receives the print data S2b transmitted via the communication line 3 (step G1) and temporarily stores it into the print data memory 5 (step G2). The printer 4B retrieves the fingerprint identification database 8 based on the first fingerprint authentication data S2a added to the print data S2b and acquires the corresponding fingerprint management information S8c, thus relating it with each set of print data s2b (step G3). The operator inputs his/her fingerprint input in the step F4 (that is, the fingerprint of the index finger of the right hand) to the fingerprint input section 6 after the inputting of the print instruction (that is, in the step F1) (step G4). The fingerprint input section 6 outputs the second fingerprint pattern data S6. Then, the printer 4B receives the second fingerprint pattern data S6, converts it into the second fingerprint authentication data, retrieves the fingerprint identification database 8 based on the second fingerprint authentication data, and thus obtains the corresponding fingerprint management information S8c (step G5).

The printer 4B retrieves whether or not the print data memory 5 has the print data S5b corresponding to the fingerprint management information S8c (step G6). If the print data memory 5 holds the print data S5b corresponding to the fingerprint management information S8c (step G7), the printer 4B prints out the print data S5b (step G8). Thereafter, the printed print data S5b is deleted out of the print data memory 5 (step G9). If the print data memory 5 does not hold the print data S5b corresponding to the fingerprint management information S8c in the step G7, the printing is not implemented. Since it is defined that the index finger and the middle finger of the right hand belong to the same person, two fingers are handled similarly. Either finger enables the same operation. This embodiment does not require providing the database for authenticating the fingerprint authentication data in the personal computer 2A or in the printer 4B. The reason is that the fingerprint is input every time the print instruction is executed and that the fingerprint authentication data S2a is added to the print data S2b.

The fourth embodiment has the following advantages (a) to (e).

(a) Every time the print instruction is executed, the fingerprint authentication data S2a is added to the print data S2b and the printer 4B authenticates an operator. Hence, even if a different operator uses the same personal computer 2A, the printing is not executed so long as the real operator itself or a person with print authority is identified. For that reason, only the operator that has executed the print instruction can actually implement the printing so that the security of the print results can be maintained.

(b) Since the printer 4B authenticates an operator itself or a person with print authority and prints only the corresponding print data S5b, it can be easily judged that the print results belong to the operator itself.

(c) Since the fingerprint identification database 8 that manages plural fingers as the same group is provided, the same authority can be provided to the plural fingers or an operator by suitably setting the management unit and registering plural fingerprints.

(d) Since printing is not performed if the operator itself which issued the print data S2b or the person which has the authority in printing does not operate the printer 4B, it is executed that the operator can quickly collect the print results. For that reason, it can be prevented that the printed sheets are piled up at the output of the printer.

(e) Since an operator or a person with print authority can reconsider whether or not to execute printing before starting, waste printing can be avoided.

Fifth Embodiment

In the network printing system with fingerprint authentication function of this embodiment, the personal computer 2A of the fourth embodiment shown in FIG. 6 converts the first fingerprint pattern data S1 into the first fingerprint authentication data S2a suitable for operator authentication and registers it. Moreover, the personal computer 2A creates the print data S2b based on the operation of the operator, adds the fingerprint management information S2c representing a personal or management unit to which the corresponding first fingerprint authentication data S2a belongs, to the first fingerprint authentication data S2a and then outputs the added data together with the print data S2b.

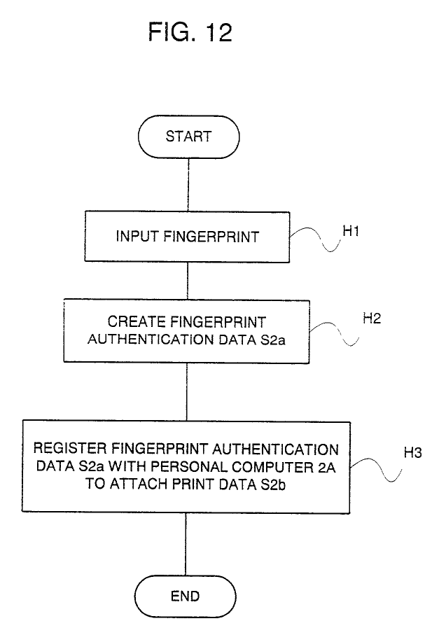

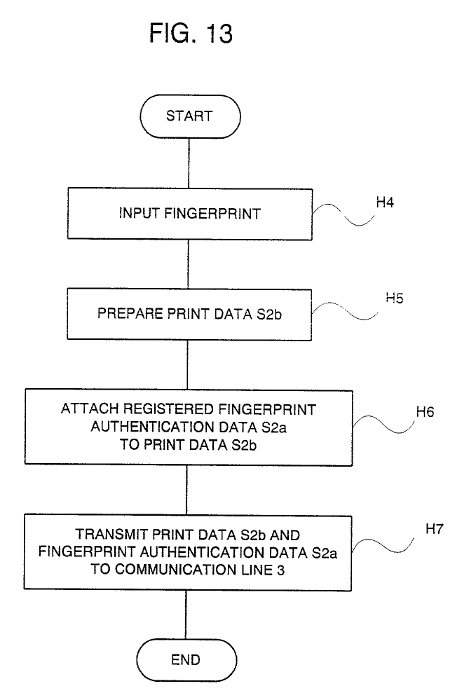

Each of FIGS. 12 and 13 is a flowchart explaining the operation of the network printing system with fingerprint authentication function. FIG. 12 is a flowchart explaining the operation of registering the fingerprint authentication data S2a in the personal computer 2A. FIG. 13 is a flowchart explaining the operation of the personal computer 2A.

The operation of the network printing system with fingerprint authentication function will be explained by referring to FIGS. 12 and 13.

The personal computer 2A, as shown in FIG. 12, receives a print instruction by the operation of an operator (step H1). The personal computer 2A receives the first fingerprint pattern data S1 and then converts it into the first fingerprint authentication data S2a (step H2), thus registering the first fingerprint authentication data S2a to the personal computer 2 (step H3). Next, the operator, as shown in FIG. 13, enters a desired print instruction during operation of the personal computer 2A (step H4). In response to the print instruction, the personal computer 2A prepares the print data S2b (step H5) and adds the first fingerprint authentication data S2a in the registered state to the print data S2b (step H6), thus transmitting the added data via the communication line 3 (step H7). The printer 4B implements operations in a manner similar to the operations in the steps G1, . . . , G9 in the fourth embodiment shown in FIG. 11.

As described above, in the fifth embodiment, it is not unnecessary that the operator inputs his/her fingerprint to the fingerprint input section 1 every printing. Hence, when the operator that operates the personal computer 2A is determined, the fifth embodiment can provide simplified manipulation, in addition to the advantage of the fourth embodiment.

Sixth Embodiment

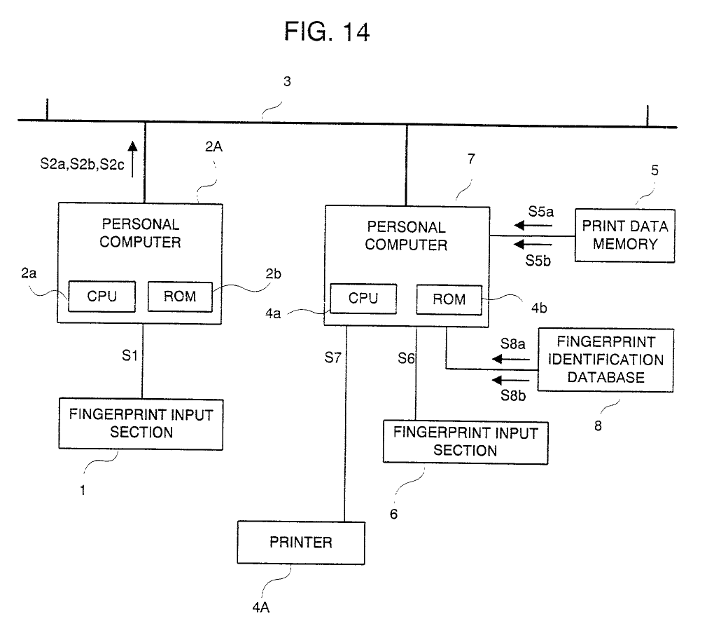

FIG. 14 is a block diagram illustrating the electrical configuration of a network printing system with fingerprint authentication function according to the sixth embodiment of the present invention. Like numerals are attached to the same constituent elements as constituent elements in the third embodiment shown in FIG. 6 and in the fourth embodiment shown in FIG. 8.

The network printing system with fingerprint authentication function differs from the fifth embodiment in the following respects.

That is, the second data processing means (for example, personal computer) 7A is provided in place of the printer 4B in FIG. 8. The printer 4A, similar to that in FIG. 6, is connected to the personal computer 7A. The personal computer 7A converts the second fingerprint pattern data S6 into the second fingerprint authentication data suitable for operator authentication and reads out the fingerprint management information S8c corresponding to the second fingerprint authentication data from the fingerprint database 8. Thus the personal computer 7A reads out print data corresponding to the fingerprint management information S8c among sets of print data S5b stored in the print data memory 5. Other operations are similar to those in FIG. 8.

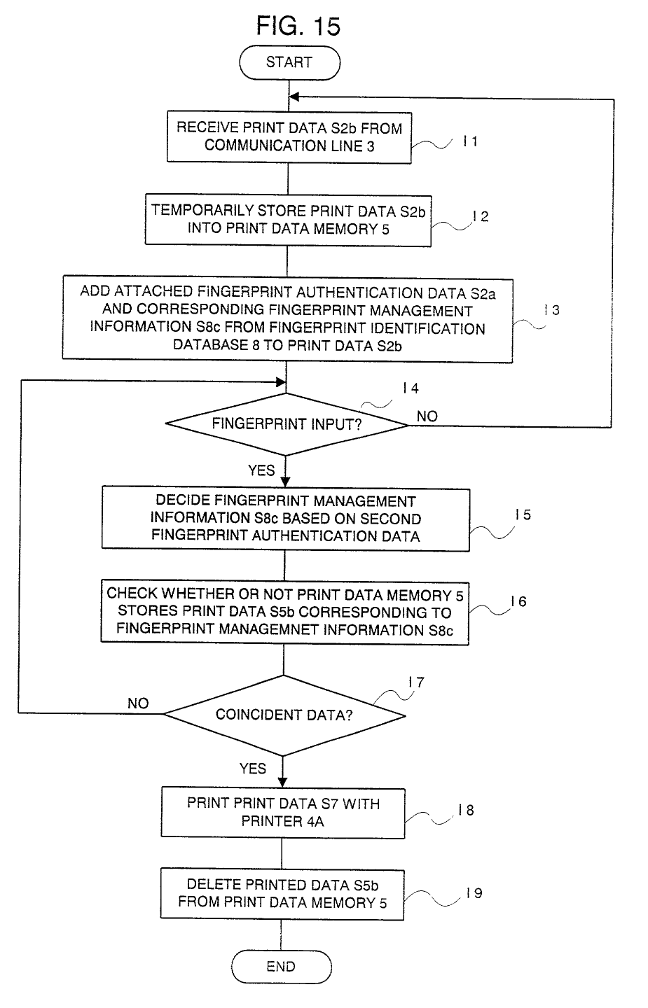

FIG. 15 is a flowchart explaining the operation of the network printing system with fingerprint authentication function.

The operation of the network printing system with fingerprint authentication function will be explained below by referring to FIG. 15.

The personal computer 2A operates similarly to the operations in the steps F1, . . . , F7 in the fourth embodiment shown in FIG. 10 and in the steps H1, . . . , H7 in the fifth embodiment shown in FIGS. 12 and 13.

The personal computer 7A, as shown in FIG. 15, receives the print data S2b transmitted via the communication line 3 (step I1) and then temporarily stores it into the print data memory 5 (step I2). The personal computer 7A also retrieves the fingerprint identification database 8 based on the first fingerprint authentication data to which the print data S2b is added, and obtains the corresponding fingerprint management information S8c, thus relating it with each of sets of print data S2b (step I3). The operator inputs to the fingerprint input section 6 his/her fingerprint (that is, the fingerprint of the index finger of the right hand) input at the time of inputting print instruction by means of the personal computer 2A. Then, the fingerprint input section 6 outputs the second fingerprint pattern data S6 (step I6). The personal computer 7A receives the second fingerprint pattern data S6 and converts it into the second fingerprint authentication data. Then, the personal computer 7A retrieves the fingerprint identification database 8 based on the second fingerprint authentication data, and then obtains the corresponding fingerprint management information S8c (step I5).

The personal computer 7A retrieves whether or not the print data memory 5 has the print data S5b corresponding to the fingerprint management information S8c (step 16). If the print data memory 5 holds print data S5b corresponding to the corresponding fingerprint management information S8c (step I7), the personal computer 7A captures the print data S5b and transmits the print data S7 to the printer 4A. Thus, the printer 4A implements its printing operation (step I8). Thereafter, the printed print data S5b is deleted out of the print data memory 5 (step I9). If the print data memory 5 does not hold the print data S5b corresponding to the fingerprint management information S8c in the step I7, the flow goes back to the step I4 and the printing operation is not carried out.

Since it is defined that the index finger and the middle finger of the right hand belong to the same person, the two fingers are handled similarly. Either finger enables the same printing operation. In this embodiment, it is unnecessary to provide the database that authenticates fingerprint authentication data, in the personal computer 2A or 7A. The reason is that the inputting of a fingerprint is carried out every time the print instruction is executed and that the fingerprint authentication data S2a is added to the print data S2b.

In the sixth embodiment, since the personal computer 7A is provided in place of the printer 4B shown in FIG. 8, the printer 4A may have a simplified configuration having only the function of printing the print data S7, together with the advantage of the third embodiment.

Seventh Embodiment

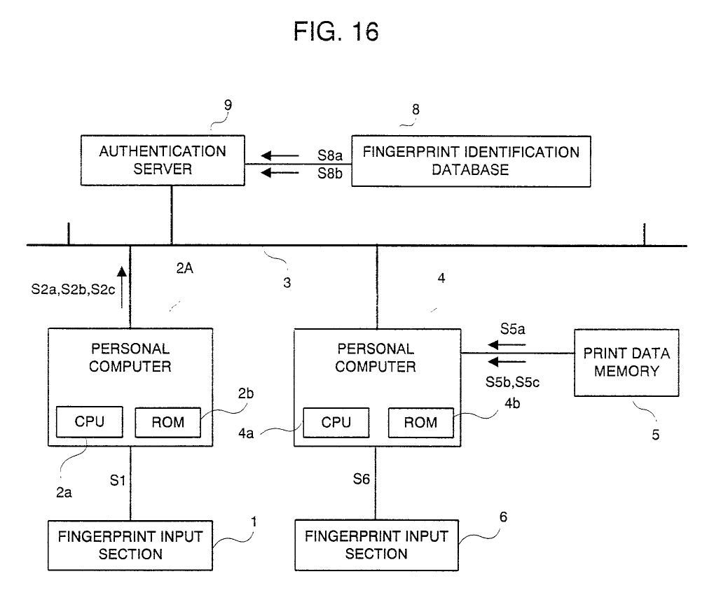

FIG. 16 is a block diagram illustrating the electrical configuration of a network printing system with fingerprint authentication function, according to the seventh embodiment of the present invention. Like numerals are attached to the same constituent elements as those in the first embodiment of FIG. 1 and in the fourth embodiment of FIG. 8.

The network printing system with fingerprint authentication function differs from that in the first embodiment in the following points.

That is, the personal computer 2A shown in FIG. 8 is used in place of the personal computer 2 shown in FIG. 1. Moreover, the fingerprint authentication server 9 is connected to the communication line 3. The fingerprint identification database 8 in FIG. 8 is connected to an authentication server 9. The authentication server 9 reads out the fingerprint management information S8c corresponding to the second fingerprint authentication data created by the printer 4 from the fingerprint identification database 8. Other configuration is similar to that shown in FIG. 1.

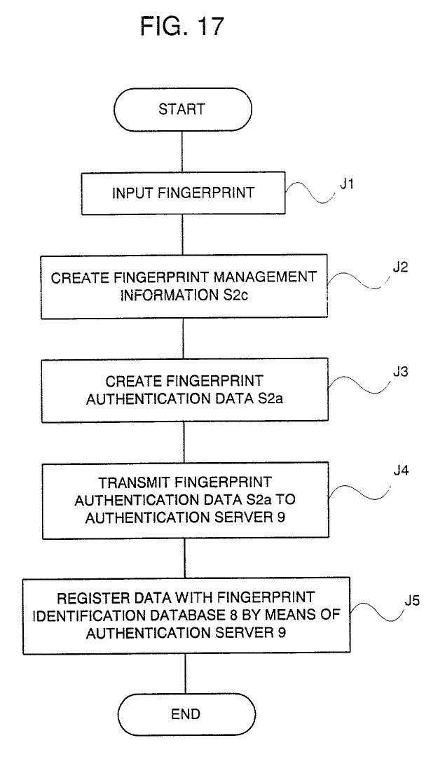

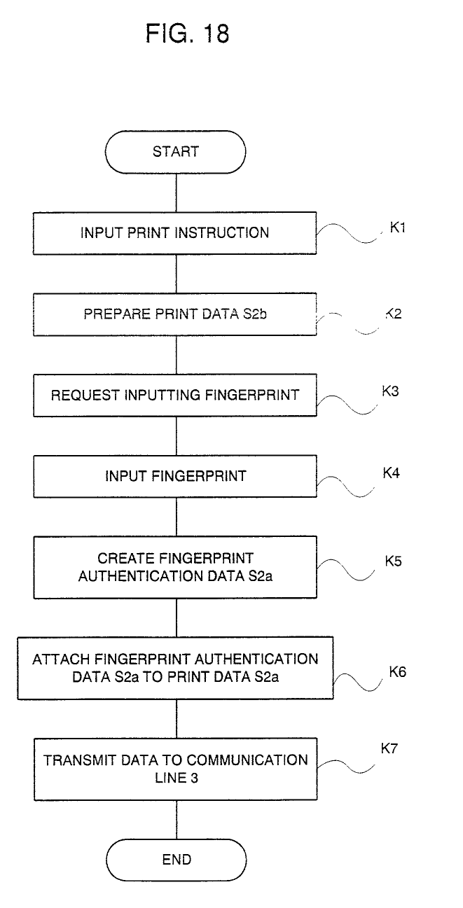

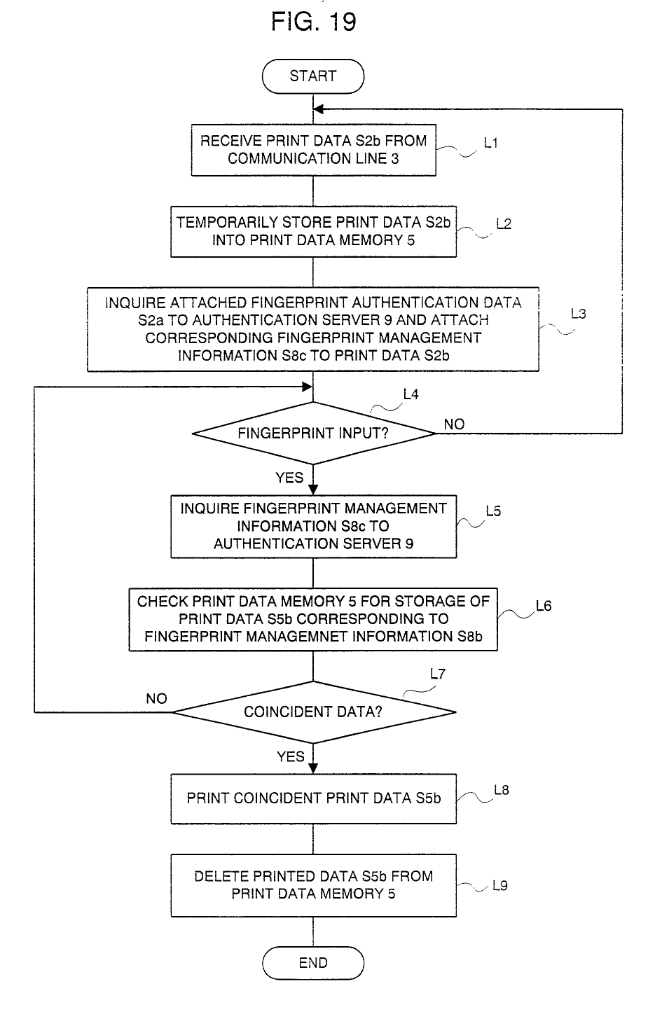

Each of FIGS. 17, 18 and 19 is a flowchart explaining the operation of the network printing system with fingerprint authentication function. FIG. 17 is a flowchart explaining the operation of registering the first fingerprint authentication data S2a and the fingerprint management information S2c in the fingerprint identification database 8. FIG. 18 is a flowchart explaining the operation of the personal computer 2A of FIG. 18. FIG. 19 is a flowchart explaining the operation of printer 4 of FIG. 19.

The operation of the network printing system with fingerprint authentication function will be explained below by referring to FIGS. 17, 18 and 19.

As shown in FIG. 17, an operator input his/her fingerprint to the fingerprint input section 1 (step J1). The fingerprint input section 1 outputs the first fingerprint pattern data S1. At this time, the operator inputs a personal or management unit belonging to the fingerprint to the personal computer 2A to create the fingerprint management information S2c (step J2). The personal computer 2A receives the first fingerprint pattern data S1 and then creates the first fingerprint authentication data S2a (step J3). The first fingerprint authentication data S2a and the fingerprint management information S2c are transmitted to the authentication server 9 via the communication line 3 (step J4). The authentication server 9 receives the first fingerprint authentication data S2a and the fingerprint management information S2c and then stores them into the fingerprint identification database 8 (step J5).

The personal computer 2A, as shown in FIG. 18, receives the print instruction under control of the operator (step K1). The personal computer 2A prepares the print data S2b (step K2) and requests the operator to input the fingerprint (step K3). The operator inputs his/her fingerprint (for example, the fingerprint of the index finger of the right hand) to the fingerprint input section 1 (step K4). The fingerprint input section 1 outputs the first fingerprint pattern data S1. The personal computer 2A receives the first fingerprint pattern data S1 and then converts it into the first fingerprint authentication data S2a (step K5). The personal computer 2A further adds the first fingerprint authentication data S2a to the print data S2b (step K6) and then transmits the added data to the communication line 3 (step K7).

The printer 4, as shown in FIG. 19, receives the print data S2b transmitted via the communication line 3 (step L1) and then temporarily stores it into the print data memory 5 (step L2). When being inquired based on the first fingerprint authentication data S2a added to the print data S2b, the authentication server 9 retrieves the fingerprint identification database 8 and obtains the corresponding fingerprint management information S8c. The corresponding management information S8c is related with each set of print data S2b (step L3). The operator inputs his/her fingerprint (that is, the fingerprint of the index finger of the right hand) to the fingerprint input section 6 at the time of issuing a print instruction by the personal computer S2b (that is, in the step L4). Thus, it is judged whether or not there is an entry of a fingerprint (step L4). The fingerprint input section 6 outputs to the second fingerprint pattern data S6. The printer 4 receives the second fingerprint pattern data S6 and converts it into the second fingerprint authentication data. When the authentication server 9 is inquired based on the second fingerprint authentication data, the authentication server 9 retrieves the fingerprint identification database 8 and obtains the corresponding index management information S8c (step L5).

The printer 4 retrieves whether or not the print data memory 5 holds the print data S5b corresponding to the fingerprint management information S8c (step L6). If the print data memory 5 holds the print data S5b corresponding to the fingerprint management information S5c (step L7), the printer 4 prints out the print data S5b (step L8). Thereafter, the printed print data S5b is deleted out of the print data memory 5 (step L9). If the print data memory 5 does not hold the print data S5b corresponding to the fingerprint management information S8c, the printing operation is not performed.

In the seventh embodiment as described above, the authentication server 9 reads out the fingerprint management information S8c corresponding to the second fingerprint authentication data created in the printer 4 from the fingerprint identification database 8. Hence, this embodiment has not only the advantage of the fourth embodiment but also the feature that the printer 4 may have the simplified structure as shown the printer in FIG. 1.

The embodiments of the present invention have been described by referring the attached drawings. It should be noted that the specific configuration is not limited to the embodiments only. The present invention will contain changes in design within the range not departing from the scope of the invention. For example, plural fingerprint input sections and plural personal computers 2 may be used. If a fingerprint suitable for authentication is input, a fingerprint input section 1 (6) of any type may be used. The communication line 3 may be a different type communication line, different from the LAN. The operation of the steps A1, . . . , A7 in the first embodiment shown in FIG. 2 may be repeated independently of the operation of the printer 4. In this case, the fingerprint of the middle finger a right hand, for example, may be input, instead of the fingerprint of the index finger of the right hand. Similarly, the steps F1, . . . , F7 shown in FIG. 10 and the steps K1, . . . , K7 shown in FIG. 18 in the fourth embodiment may be repeated independently of the operation of the printer 4B. In this case, the fingerprint of the middle finger of a right hand, for example, may be input, instead of the fingerprint of the index finger of the right hand.

As described above, in the first aspect of the present invention, the first fingerprint authentication data is added to the print data every time a print instruction is executed, so that the printer authenticates the operator. Hence, even if a different operator uses the same data processing means, the printing operation is not executed if the real operator is not identified. For that reason, the operator only that executed the print instruction can actually perform the printing operation so that the security of the print results can be maintained. Moreover, since the printer authenticates the operator and prints out only the corresponding print data, the operator can easily judged that the print results are his/her belongings. Since authentication is performed with a fingerprint of an operator, a different finger of the operator can be distinguished. Hence, the operator can select the print data of interest with a specific finger by linking types of fingers with print data. Moreover, since the printing operation is not executed if the operator that transmitted print data does not directly operate the printer, the operator can quickly collect the print results. For that reason, it can be prevented that printed sheets are piled up at the output of the printer. Since the operator can reconsider the printing operation before starting, waste printing can be avoided.

In the second aspect of the resent invention, since the data processing means registers the first fingerprint authentication data, it is unnecessary that an operator inputs his/her fingerprint to the first fingerprint input section every printing. This feature allows the operation to be simplified when a specific operator that operates the data processing means is determined.

In the third aspect of the present invention, since the second data processing means is used in place of the printer in the first aspect of the invention, the printer may include the simplified configuration having only the function of printing print data.

In the fourth aspect of the present invention, the first fingerprint authentication data is added to the print data every time a print instruction is executed, so that the printer authenticates the operator. Hence, even if a different operator uses the same data processing means, the printing operation is not executed if the operator itself or a person with print authority is identified. For that reason, only the operator that executed the print instruction can actually perform the printing operation so that the security of the print results can be maintained. Moreover, since the printer authenticates an operator itself or a person with print authority and prints out only the corresponding print data, the operator or the person with print authority can easily judged that the print results are the operator own belongings. Moreover, since the database managing plural fingers as the same group is prepared, the same authority can be given to the plural fingers or operators by suitably setting the management unit and registering the plural fingers. Moreover, since the printing operation is not executed if an operator itself or a print authorized person that transmitted the first print data does not directly operate the printer, it is expected that the operator can quickly collect the print results. For that reason, it can be prevented that printed sheets are piled up at the output of the printer. Since the operator or the print authorized person can reconsider the printing operation before starting, waste printing can be avoided.

In the fifth aspect of the present invention, an operator does not need to input his/her finger to the first fingerprint input section every printing. This feature allows the operation to be simplified when a specific operator that operates the data processing means is decided.

In the sixth aspect of the present invention, since the second data processing means is used in place of the printer in the fourth aspect of the invention, the printer may include the simplified configuration having only the function of printing print data.

In the seventh aspect of the present invention, since the authentication server reads out fingerprint management information corresponding to the second fingerprint authentication data from the database, the printer may be formed of the same type as the printer of the first aspect of the invention.

The entire disclosure of Japanese Patent Application No. 2000-044349 filed on Feb. 22, 2000 including specification, claims, drawings and summary are incorporated herein by reference in its entirety.

What is claimed is:

1. A network printing system with fingerprint authentication function, comprising:
plural first fingerprint input means each for capturing the fingerprint pattern of a finger of an operator and then issuing first fingerprint pattern data;
plural data processing means each for converting said first fingerprint pattern data into first fingerprint authentication data suitable for authentication for said operator, creating print data under control of said operator, adding said first fingerprint authentication data to said print data, and then outputting the resultant print data;
a communication line for transmitting said print data and said first fingerprint authentication data, output from each of said plural data processing means;
a memory for storing said print data and said first fingerprint authentication data, transmitted via said communication line;
second fingerprint input means for capturing the fingerprint pattern of the finger of said operator and then outputting second fingerprint pattern data; and
a printer for converting said second fingerprint pattern data into second fingerprint authentication data suitable for authentication of said operator, verifying said second fingerprint authentication data against said first fingerprint authentication data stored in said memory, capturing print data corresponding to the first fingerprint authentication data among sets of print data stored in said memory when said second fingerprint authentication data coincides with said first fingerprint authentication data, and then performing a printing operation.

2. A network printing system with fingerprint authentication function, comprising:
plural first fingerprint input means each for capturing the fingerprint pattern of a finger of an operator and then issuing first fingerprint pattern data;
plural data processing means each for converting said first fingerprint pattern data into first fingerprint authentication data suitable for authentication for said operator, registering said first fingerprint authentication data, creating print data under control of said operator, adding said first fingerprint authentication data to said print data, and then outputting the resultant print data;
a communication line for transmitting said print data and said first fingerprint authentication data, output from each of said plural data processing means;
a memory for storing said print data and said first fingerprint authentication data, transmitted via said communication line;
second fingerprint input means for capturing the fingerprint pattern of the finger of said operator and then outputting second fingerprint pattern data; and
a printer for converting said second fingerprint pattern data into second fingerprint authentication data suitable for authentication of said operator, verifying said second fingerprint authentication data against said first fingerprint authentication data stored in said memory, capturing print data corresponding to the first fingerprint authentication data among sets of print data stored in said memory when said second fingerprint authentication data coincides with said first fingerprint authentication data, and then performing a printing operation.

3. A network printing system with fingerprint authentication function, comprising:
plural first fingerprint input means each for capturing the fingerprint pattern of a finger of an operator and then issuing first fingerprint pattern data;
plural first data processing means each for converting said first fingerprint pattern data into first fingerprint authentication data suitable for authentication for said operator, creating print data under control of said operator, adding said first fingerprint authentication data to said print data, and then outputting the resultant print data;
a communication line for transmitting said print data and said first fingerprint authentication data, output from each of said plural first data processing means;
a memory for storing said print data and said first fingerprint authentication data, transmitted via said communication line;
second fingerprint input means for capturing the fingerprint pattern of the finger of said operator and then outputting second fingerprint pattern data;
second data processing means for converting said second fingerprint pattern data into second fingerprint authentication data suitable for authentication of said operator, verifying said second fingerprint authentication data against said first fingerprint authentication data stored in said memory, and reading out print data corresponding to the first fingerprint authentication data among sets of print data stored in said memory when said second fingerprint authentication data coincides with said first fingerprint authentication data; and
a printer for capturing said print data read out by said second data processing means and performing a printing operation.

4. A network printing system with fingerprint authentication function, comprising:
plural first fingerprint input means each for capturing the fingerprint pattern of a finger of an operator and then issuing first fingerprint pattern data;
plural data processing means each for converting said first fingerprint pattern data into first fingerprint authentication data suitable for authentication for said operator, creating print data under control of said operator, adding fingerprint management information to said first fingerprint authentication data, said fingerprint management information representing a personal or management unit to which said first fingerprint authentication data belong, and then outputting the resultant data together with said print data;
a communication line for transmitting said print data, said first fingerprint authentication data and said fingerprint management information, output from each of said plural data processing means;
a memory for storing said print data, said first fingerprint authentication data and said fingerprint management information, transmitted via said communication line;
second fingerprint input means for capturing the fingerprint pattern of the finger of said operator and then outputting second fingerprint pattern data;
a database for storing said first fingerprint authentication data and said fingerprint management information transmitted via said communication line; and
a printer for converting said second fingerprint pattern data into second fingerprint authentication data suitable for authentication of said operator, reading out said fingerprint management information corresponding to said second fingerprint authentication data from said database, capturing print data corresponding to the fingerprint management information among sets of print data stored in said memory, and performing a printing operation.

5. A network printing system with fingerprint authentication function, comprising:
plural first fingerprint input means each for capturing the fingerprint pattern of a finger of an operator and then issuing first fingerprint pattern data;
plural data processing means each for converting said first fingerprint pattern data into first fingerprint authentication data suitable for authentication for said operator, registering said first fingerprint authentication data, creating print data under control of said operator, adding fingerprint management information to said first fingerprint authentication data based on a print instruction, said fingerprint management information representing a personal or management unit to which said first fingerprint authentication data belong, and then outputting the resultant data together with said print data;
a communication line for transmitting said print data, said first fingerprint authentication data and said fingerprint management information, output from each of said plural data processing means;
a memory for storing said print data, said first fingerprint authentication data and said fingerprint management information, transmitted via said communication line;
second fingerprint input means for capturing the fingerprint pattern of the finger of said operator and then outputting second fingerprint pattern data;
a database for storing said first fingerprint authentication data and said fingerprint management information transmitted via said communication line; and
a printer for converting said second fingerprint pattern data into second fingerprint authentication data suitable for authentication of said operator, reading out said fingerprint management information corresponding to said second fingerprint authentication data from said database, capturing print data corresponding to the fingerprint management information among sets of print data stored in said memory, and performing a printing operation.

6. A network printing system with fingerprint authentication function, comprising:
plural first fingerprint input means each for capturing the fingerprint pattern of a finger of an operator and then issuing first fingerprint pattern data;
plural first data processing means each for converting said first fingerprint pattern data into first fingerprint authentication data suitable for authentication for said operator, creating print data under control of said operator, adding fingerprint management information to said first fingerprint authentication data, said fingerprint management information representing a personal or management unit to which said first fingerprint authentication data belong, and then outputting the resultant data together with said print data;
a communication line for transmitting said print data, said first fingerprint authentication data and said fingerprint management information, output from each of said plural data processing means;
a memory for storing said print data, said first fingerprint authentication data and said fingerprint management information, transmitted via said communication line;
second fingerprint input means for capturing the fingerprint pattern of the finger of said operator and then outputting second fingerprint pattern data;
a database for storing said first fingerprint authentication data and said fingerprint management information transmitted via said communication line;
second data processing means for converting said second fingerprint pattern data into second fingerprint authentication data suitable for authentication of said operator, reading out said fingerprint management information corresponding to said second fingerprint authentication data from said database, and capturing print data corresponding to the fingerprint management information among sets of print data stored in said memory; and
a printer for capturing said print data read out of said second data processing means and printing said print data.

7. A network printing system with fingerprint authentication function, comprising:
plural first fingerprint input means each for capturing the fingerprint pattern of a finger of an operator and then issuing first fingerprint pattern data;
plural data processing means each for converting said first fingerprint pattern data into first fingerprint authentication data suitable for authentication for said operator, creating print data under control of said operator, adding fingerprint management information to said first fingerprint authentication data, said fingerprint management information representing a personal or management unit to which said first fingerprint authentication data belong, and then outputting the resultant data together with said print data;
a communication line for transmitting said print data, said fingerprint authentication data, and said fingerprint management information, output from said data processing means;
a database for storing said first fingerprint authentication data and fingerprint management information, transmitted via said communication line;
an authentication server for reading out said fingerprint management information corresponding to second fingerprint authentication data from said database;
a memory for storing said print data, said first fingerprint authentication data, and said fingerprint management information, transmitted via said communication line;
second fingerprint input means for capturing the fingerprint pattern of a finger of each operator and then outputting second fingerprint pattern data; and
a printer for converting said second fingerprint pattern data into second fingerprint authentication data suitable for authentication of said operator, capturing print data corresponding to the fingerprint management information among sets of print data stored in said memory, and printing said captured print data.

8. A recording medium, on which a program for making a computer execute print control, said program making said computer execute the steps of:
capturing the fingerprint pattern of a finger of an operator and then creating first fingerprint pattern data;
converting said first fingerprint pattern data into first fingerprint authentication data suitable for authentication for said operator, creating print data under control of said operator, adding said first fingerprint authentication data to said print data, and then transmitting the resultant print data;
storing said print data and said first fingerprint authentication data transmitted, in a memory;
capturing the fingerprint pattern of a finger of each operator and then creating second fingerprint pattern data; and
converting said second fingerprint pattern data into second fingerprint authentication data suitable for authentication of said operator, verifying said second fingerprint authentication data against said first fingerprint authentication data stored in said memory, capturing print data corresponding to the first fingerprint authentication data among sets of print data stored in said memory when said second fingerprint authentication data coincides with said first fingerprint authentication data; and then performing a printing operation.

9. A recording medium, on which a program for making a computer execute print control, said program making said computer execute the steps of:
capturing the fingerprint pattern of a finger of an operator and then creating first fingerprint pattern data;
converting said first fingerprint pattern data into first fingerprint authentication data suitable for authentication for said operator, registering said first fingerprint authentication data, creating print data under control of said operator, adding said first fingerprint authentication data to said print data, based on a print instruction, and then transmitting the resultant print data;
storing said print data and said first fingerprint authentication data transmitted, in a memory;
capturing the fingerprint pattern of a finger of each operator and then creating second fingerprint pattern data; and
converting said second fingerprint pattern data into second fingerprint authentication data suitable for authentication of said operator, verifying said second fingerprint authentication data against said first fingerprint authentication data stored in said memory, capturing print data corresponding to the first fingerprint authentication data among sets of print data stored in said memory when said second fingerprint authentication data coincides with said first fingerprint authentication data; and then performing a printing operation.

10. A recording medium, on which a program for making a computer execute print control, said program making said computer execute the steps of:
capturing the fingerprint pattern of a finger of an operator and then creating first fingerprint pattern data;
converting said first fingerprint pattern data into first fingerprint authentication data suitable for authentication of said operator, creating print data under control of said operator, adding said first fingerprint authentication data to said print data, and then transmitting the resultant print data;
storing said print data and said first fingerprint authentication data transmitted, in a memory;
capturing the fingerprint pattern of a finger of each operator and then creating second fingerprint pattern data;
converting said second fingerprint pattern data into second fingerprint authentication data suitable for authentication of said operator, verifying said second fingerprint authentication data against said first fingerprint authentication data stored in said memory, reading out print data corresponding to the first fingerprint authentication data among sets of print data stored in said memory when said second fingerprint authentication data coincides with said first fingerprint authentication data; and
capturing said print data and performing a printing operation.

11. A recording medium, on which a program for making a computer execute print control, said program making said computer execute the steps of:
capturing the fingerprint pattern of a finger of an operator and then creating first fingerprint pattern data;
converting said first fingerprint pattern data into first fingerprint authentication data suitable for authentication of said operator, creating print data under control of said operator, adding fingerprint management information to said first fingerprint authentication data, said fingerprint management information representing a personal or management unit to which said first fingerprint authentication data belong, and then transmitting the resultant data together with said print data;
storing said print data, said first fingerprint authentication data, and said fingerprint management information transmitted, in a memory;
capturing the fingerprint pattern of a finger of each operator and then creating second fingerprint authentication data;
storing said first fingerprint authentication data and said fingerprint management information in a database; and
converting said second fingerprint pattern data into second fingerprint authentication data suitable for authentication of said operator, reading out said fingerprint management information corresponding to said second fingerprint authentication data from said database, capturing print data corresponding to the fingerprint authentication management information among sets of print data stored in said memory, and performing a printing operation.

12. A recording medium, on which a program for making a computer execute print control, said program making said computer execute the steps of:
capturing the fingerprint pattern of a finger of an operator and then creating first fingerprint pattern data;
converting said first fingerprint pattern data into first fingerprint authentication data suitable for authentication of said operator, registering said first fingerprint authentication data, creating print data under control of said operator, adding fingerprint management information to said first fingerprint authentication data based on a print instruction, said fingerprint management information representing a personal or management unit to which said first fingerprint authentication data belong, and then outputting the resultant data together with said print data;
storing said print data, said first fingerprint authentication data, and said fingerprint management information transmitted, in a memory;
capturing the fingerprint pattern of a finger of each operator and then creating second fingerprint pattern data;
storing said first fingerprint authentication data and said fingerprint management information transmitted, in a database; and
converting said second fingerprint pattern data into second fingerprint authentication data suitable for authentication of said operator, reading out said fingerprint management information corresponding to said second fingerprint authentication data from said database, capturing print data corresponding to the fingerprint authentication management information among sets of print data stored in said memory, and performing a printing operation.

13. A recording medium, on which a program for making a computer execute print control, said program making said computer execute the steps of:
capturing the fingerprint pattern of a finger of an operator and then creating first fingerprint pattern data;
converting said first fingerprint pattern data into first fingerprint authentication data suitable for authentication of said operator, creating print data under control of said operator, adding fingerprint management information to said first fingerprint authentication data, said fingerprint management information representing a personal or management unit to which said first fingerprint authentication data belong, and then transmitting the resultant data together with said print data;
storing said print data, said first fingerprint authentication data, and said fingerprint management information transmitted, in a memory;
capturing the fingerprint pattern of a finger of each operator and then creating second fingerprint authentication data;
storing said first fingerprint authentication data and said fingerprint management information transmitted, in a database;
converting said second fingerprint pattern data into second fingerprint authentication data suitable for authentication of said operator, reading out said fingerprint management information corresponding to said second fingerprint authentication data from said database, and reading out print data corresponding to the fingerprint management information among sets of print data stored in said memory; and
capturing and printing said print data read out.

14. A recording medium, on which a program for making a computer execute print control, said program making said computer execute the steps of:
capturing the fingerprint pattern of a finger of an operator and then creating first fingerprint pattern data;
converting said first fingerprint pattern data into first fingerprint authentication data suitable for authentication of said operator, creating print data under control of said operator, adding fingerprint management information to said first fingerprint authentication data, said fingerprint management information representing a personal or management unit to which said first fingerprint authentication data belong, and then outputting the resultant data together with said print data;
storing said first fingerprint authentication data and fingerprint management information transmitted, in a database;
reading out said fingerprint management information corresponding to second fingerprint authentication data from said database;
storing said print data and said first fingerprint authentication data, and said fingerprint management information transmitted via said communication line, in a memory;
capturing the fingerprint pattern of a finger of each operator and then creating second fingerprint pattern data; and
converting said second fingerprint pattern data into second fingerprint authentication data suitable for authentication of said operator, capturing print data corresponding to the fingerprint management information among sets of print data stored in said memory, and printing said captured print data.
